(19) United States
(12) Patent Application Publication
(10) Pub. No.: US 2009/0123156 A1
(43) Pub. Date: May 14, 2009

(54) METHOD AND APPARATUS FOR RECEIVING VISIBLE LIGHT SIGNAL IN A VISIBLE LIGHT COMMUNICATION SYSTEM

(76) Inventors: Jae-Seung SON, Suwon-si (KR); Jong-Hoon Ann, Suwon-si (KR); Eun-Tae Won, Seoul (KR)

Correspondence Address: CHA & REITER, LLC, 210 ROUTE 4 EAST STE 103, PARAMUS, NJ, 07652, US

(21) Appl. No.: 12/266,669

(22) Filed: Nov. 7, 2008

(30) Foreign Application Priority Data
Nov. 8, 2007 (KR) 2007-0113536

(51) Int. Cl. H04B 10/00

(52) U.S. Cl. 398/119

(57) ABSTRACT

A visible light receiver and method for a visible light communication system. A PD array converts a received optical signal to an electrical signal, a position controller outputs a control signal to adjust the position of the PD array according to values of signals output from PDs of the PD array, so that a highest output is from a predetermined area of the PD array A driving motor adjusts the position of the PD array according to the control signal received from the position controller, and a summer sums the values of the signals received from the PDs. A demodulator demodulates the output from the summer, and a decoder decodes the output of the demodulator.

### CLAIM OF PRIORITY

This application claims the benefit under 35 U.S.C. §119(a) from a Korean Patent Application filed in the Korean Intellectual Property Office on Nov. 8, 2007 and assigned Serial No. 2007-113536, the entire disclosure of which is hereby incorporated by reference in its entirety.

### BACKGROUND OF THE INVENTION

1. Field of the Invention

The present invention generally relates to a visible light communication system. More particularly, the present invention relates to a method and apparatus for receiving a visible light signal in a visible light receiver using a plurality of light receiving devices.

2. Description of the Related Art

Owing to the improved light emission efficiency and decreased price of Light Emitting Diodes (LEDs), the LEDs have recently gained popularity in the general lighting market, which includes fluorescent lighting and incandescent lighting, as well as in the special lighting market including portable devices, displays, cars, signal signs, and advertisement boards, etc.

Also, optical wireless communication technology complimentary to RF technology has attracted much interest due to the shortage of Radio Frequency (RF) bands, the possibility of entanglement between different radio communication technologies, increased demands for communication security, and the advent of an ultra-high ubiquitous communication environment of 4^{th} Generation (4G) radio technology. In this context, many companies and research institutes are studying visible light wireless communications (VLC) using visible light LEDs typically as a communication supplement to wireless technology.

LEDs with excellent performance and long lifetimes quickly become popular substitutes for fluorescent lightings and incandescent lightings in the home, offices, and public places. Modulation of a current applied to an LED used as a light enables utilization of the LED light as a communication light source in VLC. That is, without any additional light source, broadcasting and data transmission are possible only using the LED light.

Visible light communications for transmitting information by light visible to the human eye offers benefits that include a wide use band, free use without restrictions compared to RF wave communications, visibility of a communication link, and reliability in security. In addition, visible light communications are capable of providing both a lighting function and a communication function. That is, visible light communications may serve as a general light for lighting, as well as a visible light communication transceiver for information transmission/reception.

FIGS. 1A and 1B illustrate visible light receiving portions in conventional visible light receivers.

FIG. 1A illustrates a conventional visible light receiving portion using a PhotoDiode (PD) 100 as a light receiving device in a conventional visible light receiver. Referring to FIG. 1A, the visible light receiving portion includes a PD 100 for opto-electrically converting received light to an electrical signal and a lens 120 for collecting the received light onto the PD 100. The receiver receives a visible light signal from a transmitter, converts the visible light signal to an electrical signal through the lens 120 and the PD 100, and then performs a subsequent reception operation with the electrical signal.

FIG. 1B illustrates another conventional visible light receiving portion using a PD array 130 with a plurality of PDs as a light receiving device in another conventional visible light receiver. Referring to FIG. 1B, the visible light receiving portion includes a PD array with a plurality of PDs 131 to 139 for opto-electrically converting received light to an electrical signal and a lens 140 for collecting the received light onto the PD array. Light that passes through the lens 140 is received at one or more PDs 131-139 in the PD array 130 according to the reception angle of the visible light. The visible light receiver recovers the received signal by the electrical signal output from the PD that has received the light.

FIG. 2 is a block diagram of another conventional visible light receiver using a PD array with a plurality of PDs as a light receiving device. The conventional visible light receiver includes a PD array 250 with a plurality of PDs 200-1 to 200-n, for opto-electrically converting received light to electrical signals, a summer for summing the electrical signals, a demodulator 220 for demodulating the sum signal, and a decoder 230 for correcting errors in the demodulated signal using an error correction code.

A received visible light signal is subject to opto-electric conversion in the PDs 200-1 to 200-n and outputs of the PDs 200-1 to 200-n are simply summed in the summer 210.

Still referring to FIG. 2, the reason for using a plurality of PDs in a visible light receiver is the relationship between the area and response speed of a PD. Typically, as the PD area increases, the PD receives more light but operates more slowly. The increased PD area also increases resistance components, resulting in an increased time constant. Since the area of a PD is inversely proportional to its operation speed, the use of a plurality of PDs each being relatively small in area can increase the operation speed, while increasing the light receiving area.

FIG. 3 is a flowchart illustrating a reception operation of the conventional visible light receiver using a PD array with a plurality of PDs as a light receiving device. Referring now to FIG. 3, the visible light receiver receives a visible light signal from a visible light communication transmitter through the PD array 250 (shown in FIG. 2) in step 310 and sums the outputs of the PDs 200-1 to 200-n of the PD array 250 at the summer 210 in step 320. The visible light receiver demodulates the sum signal in step 330 and decodes the demodulated signal in step 340. In step 350, the visible light receiver determines whether the reception operation is completed. If the reception operation is still going on, the visible light receiver returns to step 310. Otherwise, the visible light receiver ends the reception operation.

Visible light communications that utilize light propagation in free space are under a different environment from that of optical communications using optical fibers. Because signals are transferred in optical fibers in the optical communications, transmission signals are received at a receiver without loss. Meanwhile, as a visible light signal carrying information lights a wide free space in the visible communications based on free space propagation, a visible light receiver can receive only part of the light transmitted by a visible light communication transmitter To overcome this problem, the visible light receiver uses parts like a lens for increasing the intensity of received light. That's why the visible light receiver needs a sufficient amount of light intensity received for more stable signal recovery.

The performance of the visible light receiver can be increased by arranging a plurality of light receiving devices. In this case, it can be expected that the operation speed will increase, while the light receiving area increases. In the case of using a plurality of light receiving devices, the focus of a lens on the array of light receiving devices changes in position depending on the incident angle of light on the lens. If the visible light is incident on the lens at the right angle, it focuses on the center of the array of light receiving devices. Hence, a reception operation is performed at a maximum light reception rate. However, when the incident angle is small, the focus of the lens is positioned at an edge of the array of light receiving devices and thus only part of the visible light from the lens can be received. The resulting low light reception rate of the light receiving devices leads to a low reception efficiency. Accordingly, the visible light receiver cannot recover a signal stably without a sufficient light intensity required for original signal recovery.

### SUMMARY OF THE INVENTION

The present invention provides a method and apparatus for receiving a visible light signal to increase the light reception rate of visible light incident from a lens during the reception in a visible light receiver using a PD array with a plurality of PDs.

In accordance with an aspect of an exemplary embodiment of the present invention, there is provided a visible light receiver in a visible light communication system, in which a PD array converts a received optical signal to an electrical signal, a position controller outputs a control signal to adjust the position of the PD array according to values of signals output from PDs of the PD array, a driving motor adjusts the position of the PD array according to the control signal received from the position controller, and a summer sums the values of the signals received from the PDs.

In accordance with another aspect of an exemplary embodiment of the present invention, there is provided a method for receiving a visible light signal in a visible light receiver of a visible light communication system, in which a visible light signal is received through a PD array, it is determined whether to control the position of the PD array according to values of signals received from PDs of the PD array, the position of the PD array is controlled, if the position of the PD array needs to be controlled, and the values of the signals received from the PDs of the PD array are summed.

### BRIEF DESCRIPTION OF THE DRAWINGS

The above and other exemplary objects, features and advantages of the present invention will be more apparent from the following detailed description taken in conjunction with the accompanying drawings, in which:

FIGS. 1A and 1B illustrate visible light receiving portions in conventional visible light receivers;

FIG. 2 is a block diagram of a conventional visible light receiver;

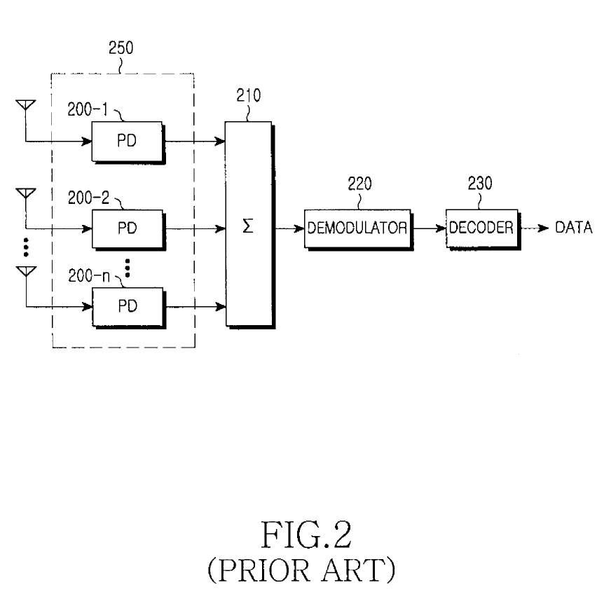

FIG. 3 is a flowchart illustrating a reception operation of the conventional visible light receiver;

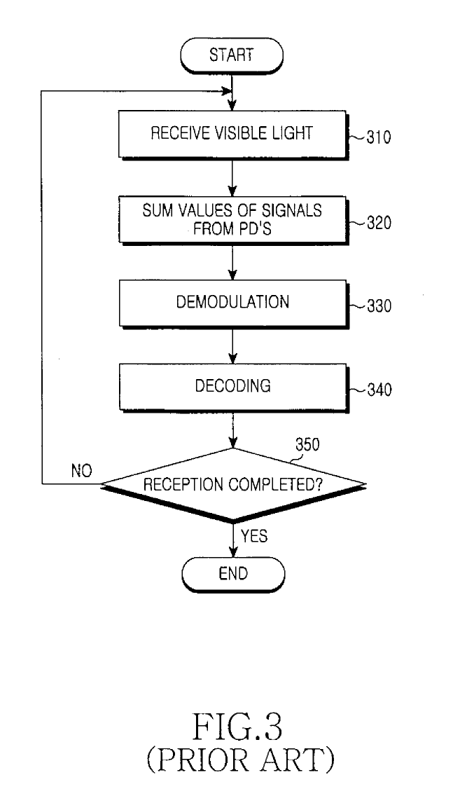

FIGS. 4A and 4B illustrate a visible light receiving portion in a visible light receiver according to an exemplary embodiment of the present invention;

FIG. 5 is a block diagram of the visible light receiver according to an exemplary embodiment of the present invention;

FIG. 6 is a flowchart illustrating a reception operation of the visible light receiver according to an exemplary embodiment of the present invention; and

FIGS. 7A and 7B illustrate an operation for controlling the position of a PD array in the visible light receiver according to an exemplary embodiment of the present invention.

Throughout the drawings, the same drawing reference numerals will be understood to refer to the same elements, features and structures.

### DETAILED DESCRIPTION

The matters defined in the description such as a detailed construction and elements are not provided for limitation, but rather for illustration to assist in a comprehensive understanding of certain exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions may be omitted for clarity and conciseness when their inclusion would obscure appreciation of the subject matter of the present invention by a person of ordinary skill in the art.

There is a light receiving position in an array of light receiving devices, which offers an optimal light receiving rate during reception of a visible light signal in a visible light receiver. The present invention proposes a method for maximizing a light receiving rate regardless of the incident angle of received light by optimizing the position of a light receiving device array with PDs during reception of a visible light signal.

A description will be made below of a signal reception method in a light receiving device in a visible light communication system according to an exemplary embodiment of the present invention.

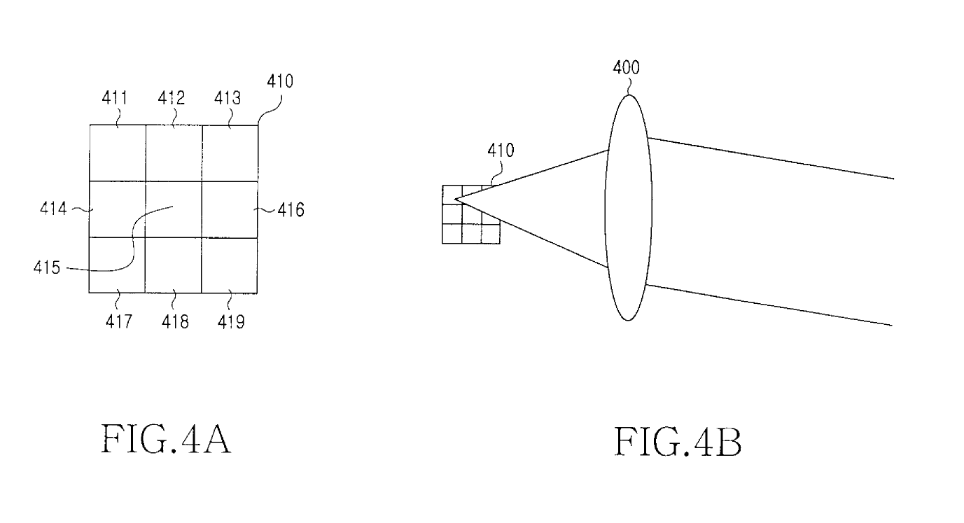

FIGS. 4A and 4B illustrate a visible light receiving portion in a visible light receiver according to an exemplary embodiment of the present invention.

FIG. 4A illustrates a PD array with a plurality of PDs. Referring to FIG. 4A, a PD array 410 includes a plurality of PDs 411 to 419 on a plane, each PD operating independently.

FIG. 4B illustrates a visible light receiving portion using a PD array with a plurality of PDs in a visible light receiver according to an exemplary embodiment of the present invention. The visible light receiving portion includes the PD array 410 for opto-electrically converting received light to an electrical signal and a lens 400 for collecting the received light onto the PD array 410. In FIG. 4B, the light received at the visible light receiving portion is incident from a lateral side of the lens 400.

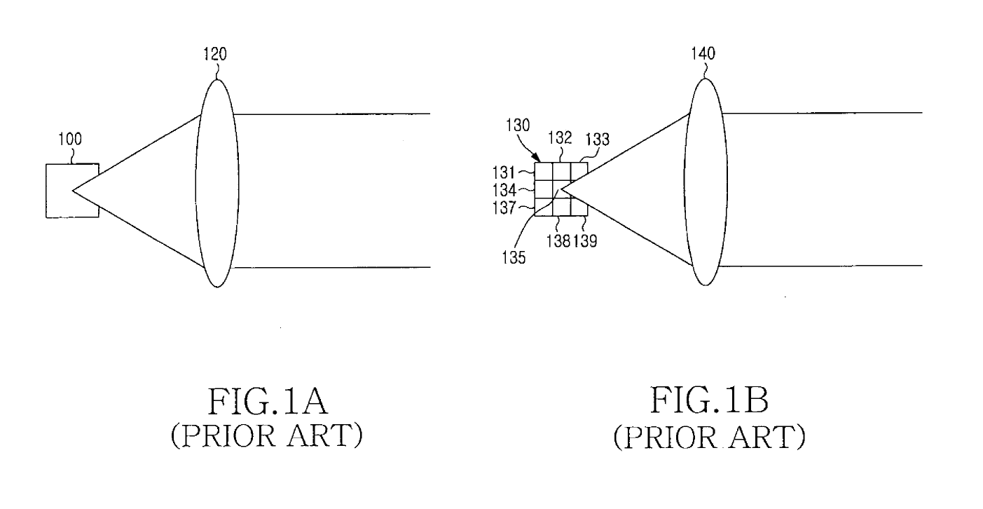

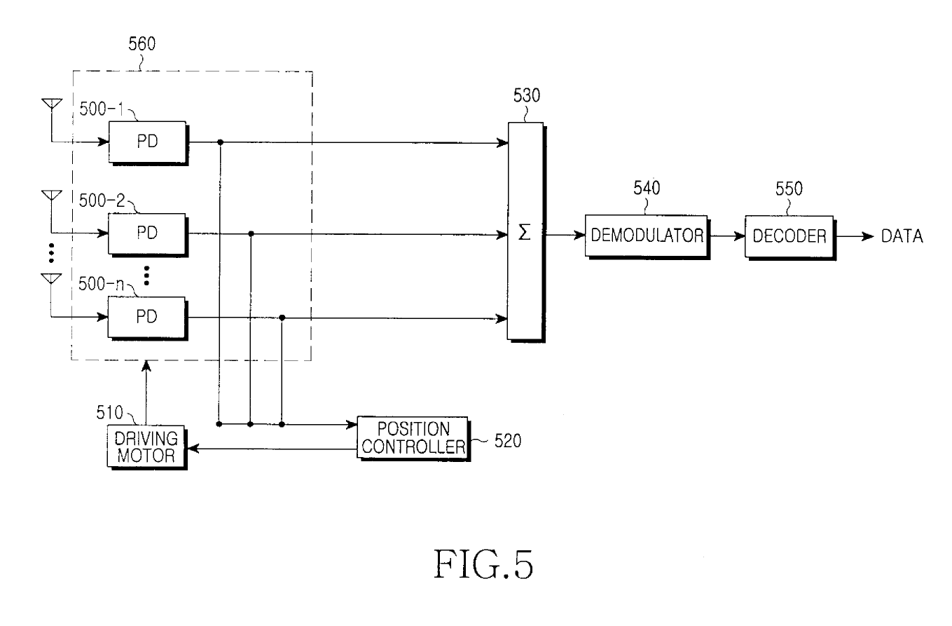

Compared to the light receiving portions illustrated in FIGS. 1A and 1B, in which light is incident perpendicularly to the lens, the light that has passed through the lens 400 may focus onto a particular part other than the center of the PD array 410 (e.g. a predetermined area of predetermined part), not onto the center of the PD array 410. Also, the light may be received at one or more PDs according to the reception angle of the light. The visible light receiver recovers received data by electrical signals from the one or more PDs. According to the present invention, the position of the PD array 410 is controlled such that the incident light focuses onto the center of the PD array 410 when the PD array 410 receives the visible light from the lens 400. With reference to FIG. 5, the configuration of the visible light receiver for the control of the PD array will be described below.

FIG. 5 is a block diagram of the visible light receiver according to an exemplary embodiment of the present invention.

Referring now to FIG. 5, the visible light receiver includes a PD array 560 with a plurality of PDs 500-1 to 500-n for opto-electrically converting received light to an electrical signal, a position controller 520 for outputting a control signal to control the position of the PD array 560, a driving motor 510 for adjusting the position of the PD array 560 according to the control signal received form the position controller 520, a summer 530 for summing the outputs of the PDs 500-1 to 500-n, a demodulator 540 for demodulating the sum signal, and a decoder 550 for decoding the demodulated signal.

Still referring to FIG. 5, a description will now be made of a method for controlling the position of a light receiving device during receiving a visible light signal in the thus-constituted visible light receiver according to an exemplary embodiment of the present invention. The PDs 500-1 to 500-n opto-electrically convert received visible light signals to electrical signals. The position controller 520 decides the values of the signals received from the PDs 500-1 to 500-n and controls the position of the PD array 560 so as to maximize a visible light reception rate. The summer 530 sums the values of the signals received from the PDs 500-1 to 500-n during or after the position control operation. The demodulator 540 demodulates the sum and the decoder 550 decodes the demodulated signal.

With reference to FIGS. 4A and 4B, the method for positioning the PD array 560 will be described in more detail. Light collected by the lens 400 is focused on one of the PDs of the PD array 410. For example, when the lens 400 focuses on the PD 411, the received light concentrates on the PD 411, while partially illuminating neighbor PDs 412, 414, and 415. Thus, the reception power of the PD 411 is maximized, larger than those of the neighbor PDs 412, 414 and 415.

However, when the visible light incident from the lens 400 focuses on the center 415 of the PD array 410, the visible light receiver operates with a maximum light reception efficiency Since the focus is on the edge 411 other than the center 415 of the light receiving device array, the visible light receiver is not in the best state in terms of light reception efficiency. Therefore, the phase/position controller 520 (FIG. 5) is aware of the relative position of the PD 411 with the largest output value in the PD array 410 and thus controls the position of the PD array 410 so that the lens 400 can focus on the center of the PD array 410. As the PDs 411 to 419 continues to receive light even during the position control, the position control does not affect the operation of the visible light receiver.

After receiving a visible light signal with a high light reception efficiency by the control operation of the position controller 520, the outputs of the PDs are summed in the summer 530, demodulated in the demodulator 540, and decoded for error correction in the decoder 550.

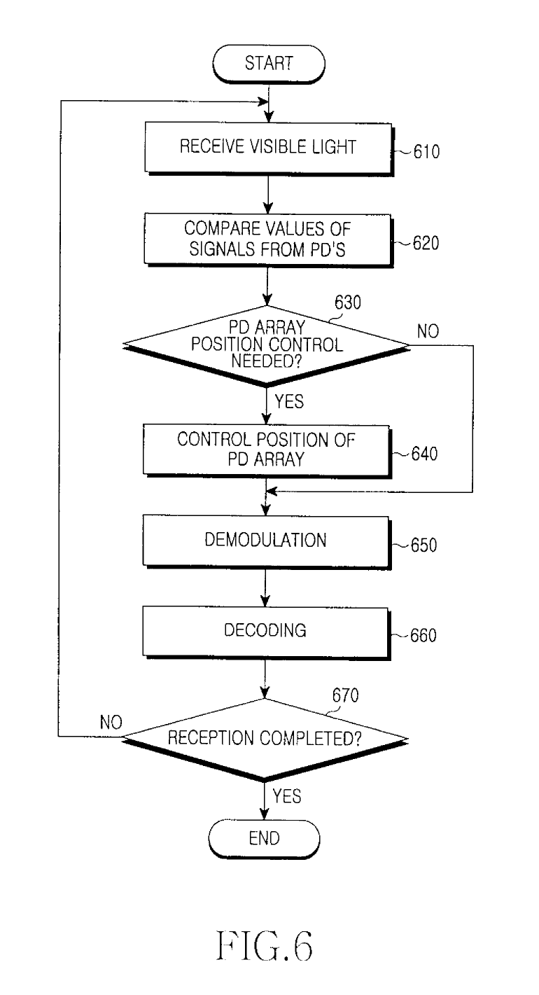

FIG. 6 is a flowchart illustrating an exemplary reception operation of the visible light receiver according to an exemplary embodiment of the present invention. Referring now to FIG. 6, when the visible light receiver starts its reception operation, the PDs 500-1 to 500-n receive visible light signals in step 610. The position controller 520 compares the output values of the PDs 500-1 to 500-n in step 620 and determines whether to adjust the position of the PD array 560 in step 630. If the position adjustment is required, the position controller 520 adjusts the position of the PD array 560 by transmitting a position control signal to the driving motor 510 such that the focus of visible light incident through the lens is on the center of the PD array 560 in step 640 and then the visible light receiver goes to step 650. On the other hand, if the position adjustment is not needed, the visible light receiver jumps to step 650. In step 650, the summer 530 sums the output values of the PDs 500-1 to 500-n and the demodulator 540 demodulates the sum. The decoder 550 then decodes the demodulated signal in step 660. In step 670, the visible light receiver determines whether the reception operation is completed. If the reception operation is still going on, the visible light receiver returns to step 610 and otherwise, it ends the reception operation.

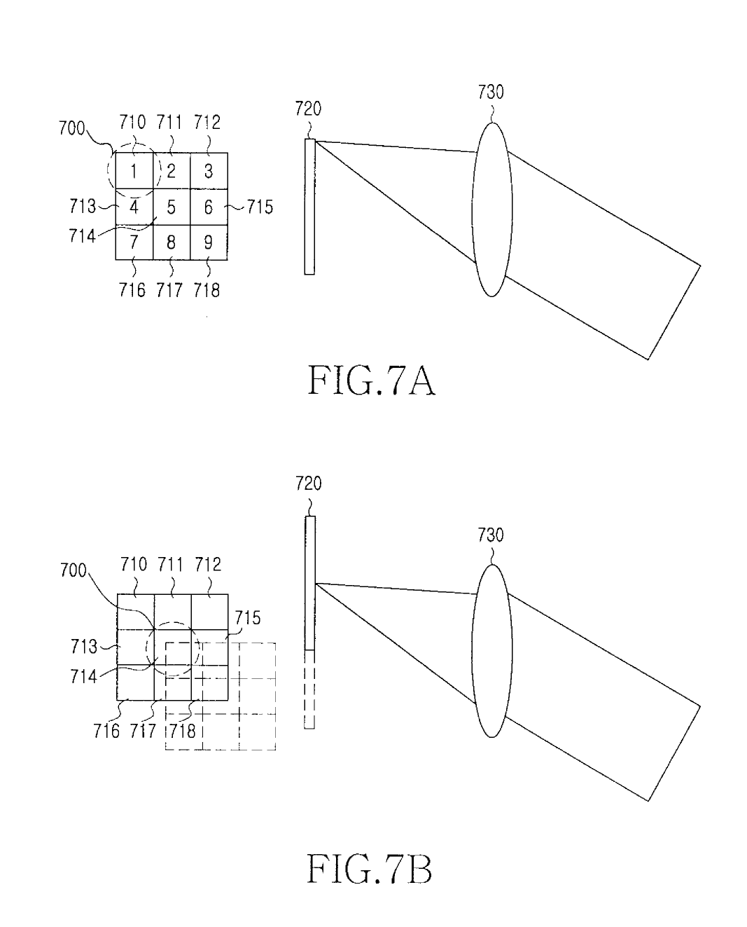

FIGS. 7A and 7B illustrate an exemplary operation for controlling the position of the PD array in the visible light receiver according to an exemplary embodiment of the present invention. With reference to FIGS. 7A and 7B, the operation for controlling the position of the PD array according to the present invention will be described.

Referring now to FIG. 7A, the visible light receiving portion includes a PD array 720 with a plurality of PDs 710 to 718 and a lens 730. When light is incident on the lens 730 at an angle smaller than the right angle, the light from the lens 730 focuses on a particular PD 710. Since part of the received light can go beyond the PD array 720, the whole light reception rate decreases.

According to the present invention, the PD array 720 is positioned optimally through the position controller 520 and the driving motor 510. Referring to FIG. 7B, a dotted line indicates the position of the PD array 720 before control of the position controller 520 and a solid line indicates the position of the PD array 720 after the control of the position controller 520. Therefore, the focus of the visible light shifts from the PD 710 at an edge to the PD 714 at the center of the PD array 720.

The determination as to whether a position adjustment is required is made in step 630 of FIG. 6 as follows. The position controller 520 determines that a PD with the largest output value is the PD on which the lens 730 focuses. If the focus is not physically at the center of the PD array 720, the position controller 520 monitors the PD with the highest output value and calculates the distance between the PD with the highest output value and the central PD. If the focus of the lens 730 is on the PD 710 as illustrated in FIG. 7A, the PD array 720 should be moved so that the light focuses on the center PD 714. Hence, the position controller 510 transmits to the driving motor 520 a control signal commanding it to move the PD array 720 to the left by one PD and up by one PD (as shown in FIG. 7B).

As is apparent from the above description, the present invention advantageously enables reception of an optical signal with a maximum light reception efficiency regardless of the incident angle of the received visible light by controlling the position of a PD array such that the light reception rate of a visible light signal incident from a lens is maximized in a visible light receiver using the PD array with a plurality of PDs.

While the invention has been shown and described with reference to certain exemplary embodiments of the present invention thereof it will be understood by those skilled in the art that various changes in form and details may be made therein without departing from the spirit and scope of the present invention as defined by the appended claims.

What is claimed is:

1. A visible light receiver in a visible light communication system, comprising:
a PhotoDiode (PD) array comprising a plurality of PDs for converting a received optical signal into an electrical signal;
a position controller for outputting a control signal for adjusting a position of the PD array according to values of signals output from the PDs of the PD array;
a driving motor for adjusting the position of the PD array according to the control signal received from the position controller; and
a summer for summing values of the signals received from the PDs of the PD array.

2. The visible light receiver of claim 1, wherein the PD array comprises a plurality of PDs arranged on a plane.

3. The visible light receiver of claim 11 wherein each PD of the PD array operates independently.

4. The visible light receiver of claim 1, wherein the position controller adjust the position of the PD array relative to a position of a lens.

5. The visible light receiver of claim 1, wherein the PD array is adjusted relative to a focal point of a lens.

6. The visible light receiver of claim 1, wherein the position controller outputs a control signal for controlling the position of the PD array so that visible light incident on the PD array focuses on a center of the PD array.

7. The visible light receiver of claim 1, further comprising a demodulator for demodulating an output of the summer.

8. The visible light receiver of claim 7, further comprising a decoder for decoding an output of the demodulator.

9. A method for receiving a visible light signal in a visible light receiver of a visible light communication system, comprising:
(a) receiving a visible light signal through a PhotoDiode (PD) array;
(b) determining whether the PD array is positioned so a focus of visible light incident through the lens is incident on a predetermined area of the PD array according to values of signals received from PDs of the PD array;
(c) controlling movement of a position of the PD array, if it is determined in step (b) that the position of the PD array needs to be changed; and
(d) summing the values of the signals received from the PDs of the PD array.

10. The method of claim 9, wherein the step (b) comprises determining that the position of the PD array needs to be moved, if a PD with a highest output strength is not a PD at a center of the PD array.

11. The method of claim 10, wherein the step (b) comprises determining that the position of the PD array needs to be moved, if a PD with a highest output strength is not a PD at a predetermined location of the PD array.

12. The method of claim 10, wherein the predetermined area of the PD array is a center of the array, and the control comprises controlling the position of PD array so that visible light incident on the PD array focuses on the center of the PD array.

13. The method of claim 10, wherein the control comprises signaling a driving motor to change a position of the PD array so that visible light incident on the PD array focuses in a greatest concentration on the predetermined area of the PD array.

14. The method according to claim 10, further comprising summing values of the signals received from the PDs of the PD array.

15. The method according to claim 14, further comprising demodulating the summed values of signals received from the PDs of the PD array.

16. The method according to claim 15, further comprising decoding an output of the demodulator.
